(19) United States
(12) Patent Application Publication
(10) Pub. No.: US 2024/0081186 A1
(43) Pub. Date: Mar. 14, 2024

(54) AUTOMATED CROP HARVESTERS AND RELATED METHODS

(71) Applicants: Ricky Gentiel Derycke, Turkey Point (CA); Steven Robert Spanjers, Eden (CA)

(72) Inventors: Ricky Gentiel Derycke, Turkey Point (CA); Steven Robert Spanjers, Eden (CA)

(21) Appl. No.: 18/465,518

(22) Filed: Sep. 12, 2023

Related U.S. Application Data
(60) Provisional application No. 63/405,792, filed on Sep. 12, 2022.

(51) Int. Cl. A01D 75/02; A01D 61/00; A01D 67/00; B25J 9/16

(52) U.S. Cl. CPC A01D 75/02; A01D 61/00; A01D 67/00; B25J 9/1679; B25J 9/1697

(57) ABSTRACT

An automated crop harvester includes: (a) a frame; (b) a drive system supporting the frame for movement of the frame along a ground surface in a harvesting direction; and (c) a plurality of articulated robot arms mounted to the frame and spaced laterally apart from each other generally perpendicular to the harvesting direction for harvesting crops in corresponding crop rows. Each robot arm has end-of-arm tooling automatically movable laterally relative to the frame into alignment with respective crops projecting from the ground surface for cutting and collecting the crops.

### CROSS-REFERENCE TO RELATED APPLICATIONS

This application claims the benefit of U.S. Provisional Application No. 63/405,792, filed on Sep. 12, 2022, which is hereby incorporated herein by reference in its entirety.

### FIELD

The present disclosure relates generally to agricultural harvesting, and more specifically, to automated harvesters for harvesting vegetable crops.

### INTRODUCTION

Mass harvesting of certain vegetable crops (e.g. asparagus, broccoli, celery, etc.) can be time consuming and labor intensive when done manually. There is a need for automated harvesters that can more efficiently and effectively harvest fields of such crops.

### SUMMARY

The following summary is intended to introduce the reader to various aspects of the applicant's teaching, but not to define any invention.

According to some aspects, an automated crop harvester includes: (a) a frame; (b) a drive system supporting the frame for movement of the frame along a ground surface in a harvesting direction; and (c) a plurality of articulated robot arms mounted to the frame and spaced laterally apart from each other generally perpendicular to the harvesting direction for harvesting crops in corresponding crop rows. Each robot arm has end-of-arm tooling automatically movable relative to the frame between at least one harvesting position adjacent the ground surface for gripping and cutting crops projecting from the ground surface, and at least one drop-off position spaced apart from the harvesting position for releasing the crops for further processing.

In some examples, the harvesting and drop-off positions are spaced horizontally apart, and each arm has at least one rotary joint operable to move the end-of-arm tooling horizontally for movement between the harvesting and drop-off positions.

In some examples, the drop-off position is at an elevation above the harvesting position, and each arm has a linear actuator operable to translate the end-of-arm tooling vertically for movement between the harvesting and drop-off positions.

In some examples, the harvester includes one or more conveyors supported by the frame and extending along the harvesting direction for conveying the crops therealong. Each conveyor extends between an upstream end adjacent at least one drop-off position for receiving crops released from a corresponding robot arm, and a downstream end adjacent a storage receptacle supported by the frame for depositing the crops in the storage receptacle. In some examples, each conveyor is positioned laterally intermediate a corresponding pair of the robot arms for receiving crops from each robot arm of the pair of the robot arms.

In some examples, the robot arms are arranged in a parallel configuration, in which the work envelopes of the robot arms are spaced laterally apart for harvesting crops in corresponding crop rows extending parallel with the harvesting direction, and the relative positioning of the robot arms is reconfigurable to a series configuration in which the work envelopes of at least one pair of adjacent robot arms are generally in lateral alignment for harvesting crops from a common crop row.

In some examples, the frame is adjustable for reconfiguration of the robot arms between the parallel and series configurations.

In some examples, the frame has a central portion supported by the drive system and to which a pair of inner robot arms of the plurality of robots arms is mounted, and a pair of side portions movably mounted on laterally opposite sides of the central portion. Each side portion has a corresponding outer robot arm of the plurality of robot arms mounted thereto. Each side portion is movable relative to the central portion between an extended position for positioning the outer robot arm in the parallel configuration with an adjacent inner robot arm, and a withdrawn position for positioning the outer robot arm in the series configuration with the adjacent inner robot arm.

In some examples, when in the extended position, the side portion projects laterally away from the central portion to position the work envelope of the outer robot arm laterally outboard of the central portion of the frame, and when in the withdrawn position, the side portion is withdrawn toward the central portion to position the work envelope of the outer robot arm laterally inboard of the central portion and generally in lateral alignment with the work envelope of the adjacent inner robot arm.

In some examples, each side portion is pivotably mounted to the central portion for swinging about a vertical swing axis between the extended and withdrawn positions.

In some examples, the frame has a plurality of interconnected frame members fixed in position relative to each other during normal operation, and each robot arm has a base fixed to a corresponding frame member and at least one link rotatably mounted to the base through a rotary joint for moving the end-of arm tooling relative to the base.

In some examples, each robot arm is suspended from the frame directly above the ground surface.

In some examples, the end-of-arm tooling has a gripper movable between an open position for receiving and releasing the crops and a closed position for gripping the crops, and a cutter adjacent the gripper for cutting the crops from the ground surface.

In some examples, when in the closed position, the gripper defines a vertical channel for holding the crops and the cutter is in fixed position relative to the channel, and the gripper is shaped to guide the crop into engagement with the cutter during forward movement of the end-of-arm tooling relative to the crop.

In some examples, the harvester includes a control system including a crop detection system having one or more crop sensors operable to detect positioning of crops projecting from the ground surface relative to the harvester, and a control unit operable to control operation of the robot arms based on the positioning of the crops to move the end-of-arm tooling between corresponding harvesting and drop-off positions for harvesting the crops.

In some examples, the crop detection system comprises a vision system including one or more imaging sensors operable to generate image data for determining the positioning of the crops.

In some examples, the control system includes a harvester positioning system operable to detect positioning of the harvester relative to the ground surface, and the control unit is operable to control operation of the drive system based on the positioning of the harvester to drive the harvester along a preselected harvesting route.

According to some aspects, a method of harvesting crops using an automated crop harvester having a plurality of articulated robot arms includes: (a) driving the crop harvester along a ground surface in a harvesting direction; (b) moving end-of-arm tooling of each robot arm to a harvesting position adjacent the ground surface to grip and cut crops from a corresponding crop row extending parallel to the harvesting direction, and while gripping the crops cut from the ground surface, moving the end-of-arm tooling to a drop-off position to release the crop from the end-of-arm tooling at the drop-off position; and (c): repeating (b) continuously during (a) in a continuous automated harvesting process. In some examples, moving the end-of-arm tooling between the harvesting and drop-off positions includes actuating a rotary joint of the robot arm to move the end-of-arm tooling horizontally.

According to some aspects, a method of harvesting crops using an automated crop harvester having a plurality of robot arms includes: (a) operating the harvester in a parallel configuration in which the work envelopes of the robot arms are spaced laterally apart from each other for harvesting crops in corresponding crop rows extending parallel to each other; and (b) operating the harvester in a series configuration in which the work envelopes of at least one pair of the robot arms are generally in lateral alignment for harvesting crops in a common crop row.

According to some aspects, an automated crop harvester includes: (a) a frame; (b) a drive system supporting the frame for movement of the frame along a ground surface in a harvesting direction; and (c) a plurality of robot arms mounted to the frame and spaced laterally apart from each other generally perpendicular to the harvesting direction for harvesting crops in corresponding crop rows. Each robot arm has end-of-arm tooling automatically movable laterally relative to the frame into alignment with respective crops projecting from the ground surface for cutting and collecting the crops.

In some examples, the harvester further includes a crop suction system mounted to the frame and in fluid communication with each end-of-arm tooling, the suction system operable to generate a suction force at each end-of-arm tooling to suction crops cut by the end-of-arm tooling and transport the crops to a storage receptacle supported by the frame.

In some examples, each end-of-arm tooling comprises a suction head having a suction port coupled to the suction system and through which the crops are suctioned for transport toward the storage receptacle.

In some examples, the suction head includes a housing having an interior extending along a vertical axis between a lower end and an upper end of the interior. The housing has a crop inlet extending vertically along and open to the interior for loading crops into the interior. The suction port is open to the interior of the housing and spaced apart from the crop inlet for suctioning crops received in the interior.

In some examples, the end-of-arm tooling includes a cutter at the lower end of the interior in alignment with the crop inlet for cutting the crops from the ground surface for loading into the interior through the crop inlet.

In some examples, the suction head includes a rotary feeder in the interior and rotatable about the vertical axis relative to the housing for moving crops received in the interior from the crop inlet toward the suction port.

In some examples, the rotary feeder includes a plurality of vanes extending vertically along the interior and spaced circumferentially apart from each other for separating the interior into a plurality of chambers spaced circumferentially apart from each other. The plurality of chambers includes at least one loading chamber in alignment with the crop inlet for receiving crops, and at least one suction chamber spaced circumferentially apart from the loading chamber and in fluid communication with the suction port for suctioning the crops from the suction chamber.

In some examples, the suction system comprises at least one suction drive for generating the suction force, and a conduit system coupling and providing fluid communication between the suction drive and the suction port of each end-of-arm tooling for conveying the crops through the conduit system.

In some examples, the conduit system comprises one or more collection chambers for collecting crops being conveyed through the conduit system. Each collection chamber has a chamber inlet coupled to one or more suction ports through an upstream conduit assembly of the conduit system and a chamber outlet coupled to the suction drive through a downstream conduit assembly of the conduit system.

In some examples, each collection chamber is provided in a hopper having a discharge mechanism operable to selectively discharge crops from the collection chamber for deposit into a respective storage receptacle under the hopper.

In some examples, the discharge mechanism comprises a discharge opening below the collection chamber and a discharge valve between the collection chamber and the discharge opening. The discharge valve is operable to selectively discharge the crops from the collection chamber through the discharge opening for deposit into the storage receptacle.

In some examples, the discharge valve comprises a rotary feeder rotatable about a horizontal axis between at least one first position for receiving the crops in the collection chamber and at least one second position for discharging the received crops through the discharge opening.

In some examples, the harvester includes at least one conveyor mounted to the frame for advancing the storage receptacle into alignment with the discharge opening of a respective hopper for receiving crops discharged from the hopper.

In some examples, each arm has at least one rotary joint operable to move the end-of-arm tooling laterally relative to the frame for lateral alignment with respective crops, and at least one linear actuator operable to translate the end-of-arm tooling vertically relative to the frame for vertical alignment with the crops.

In some examples, the robot arms are arranged in a parallel configuration, in which the work envelopes of the robot arms are spaced laterally apart for harvesting crops in corresponding crop rows extending parallel with the harvesting direction, and the relative positioning of the robot arms is reconfigurable to a series configuration in which the work envelopes of at least one pair of adjacent robot arms are generally in lateral alignment for harvesting crops from a common crop row.

In some examples, the frame is adjustable for reconfiguration of the robot arms between the parallel and series configurations.

In some examples, the harvester further includes a control system including a crop detection system having one or more crop sensors operable to detect positioning of crops projecting from the ground surface relative to the harvester, and a control unit operable to control operation of the robot arms based on the positioning of the crops to move the end-of-arm tooling into alignment with the crops.

In some examples, the crop detection system comprises a vision system including one or more imaging sensors operable to generate image data for determining the positioning of the crops.

According to some aspects, an automated crop harvester includes: (a) a frame; (b) a drive system supporting the frame for movement of the frame along a ground surface in a harvesting direction; and (c) a plurality of robot arms mounted to the frame for harvesting crops. Each robot arm has end-of-arm tooling movable relative to the frame for alignment with and harvesting of respective crops. The harvester further includes (d) a crop suction system mounted to the frame and configured to suction crops harvested by the end-of-arm tooling and transport the crops through suction toward a storage receptacle supported by the frame.

In some examples, each end-of-arm tooling comprises a cutter for cutting the crops from the ground surface and a suction head above the cutter. The suction head has a suction port coupled to the suction system and through which crops cut by the end-of-arm tooling are suctioned for transport toward the storage receptacle.

### DRAWINGS

For a better understanding of the described examples and to show more clearly how they may be carried into effect, reference will now be made, by way of example, to the accompanying drawings in which:

FIG. 1 is a front perspective view of an example automated harvester;

FIG. 2 is a rear perspective view of the harvester of FIG. 1;

FIG. 3A is an enlarged view of a portion of FIG. 1, showing an example harvesting position for end-of-arm tooling of the harvester;

FIG. 3B is an enlarged view like that of FIG. 3A, but showing an example drop-off position for the end-of-arm tooling;

FIG. 4 is a side elevation view of the harvester of FIG. 1, and schematically showing control system components of the harvester;

FIG. 5 is an enlarged view of a portion of FIG. 4, showing a robot arm of the harvester;

FIG. 6A is an enlarged view of a portion of FIG. 1, showing a gripper of the harvester in an open position;

FIG. 6B is an enlarged view of another portion of FIG. 1, showing another gripper of the harvester in a closed position;

FIG. 7 is a front elevation view of the harvester of FIG. 1;

FIG. 8 is a top view of the harvester of FIG. 1;

FIG. 9 is a top view like that of FIG. 8, but showing robot arms of the harvester reconfigured into a series configuration;

FIG. 10 is a front perspective view of another example automated harvester;

FIG. 11 is a rear perspective view of the harvester of FIG. 10;

FIG. 12 is an enlarged perspective view of a portion of FIG. 10, showing an example end-of-arm tooling of the harvester;

FIG. 13 is another perspective view of the end-of-arm tooling of FIG. 12, with a lower portion of a rotary feeder removed;

FIG. 14 is a schematic top cross-sectional view of a portion of the end-of-arm tooling of FIG. 12;

FIG. 15 is a top view of the end-of-arm tooling of FIG. 12;

FIG. 16 is a cross-sectional view of the end-of-arm tooling of FIG. 15, taken along line B-B in FIG. 15;

FIG. 17 is an exploded perspective view of portions of the end-of-arm tooling of FIG. 12;

FIG. 18 is a side elevation view of the harvester of FIG. 10;

FIG. 19 is a rear perspective view of a portion of the harvester of FIG. 11;

FIG. 20 is a side elevation view of a portion of the harvester of FIG. 18; and

FIG. 21 is a schematic rear cross-sectional view of a crop collection chamber of the harvester of FIG. 10.

The drawings included herewith are for illustrating various examples of apparatuses and methods of the teaching of the present specification and are not intended to limit the scope of what is taught in any way.

### DESCRIPTION OF VARIOUS EXAMPLES

Various apparatuses or processes will be described below to provide an example of each claimed invention. No example described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an example of any claimed invention. Any invention disclosed in an apparatus or process described below that is not claimed in this document may be the subject matter of another protective instrument, for example, a continuing patent application, and the applicants, inventors, or owners do not intend to abandon, disclaim, or dedicate to the public any such invention by its disclosure in this document.

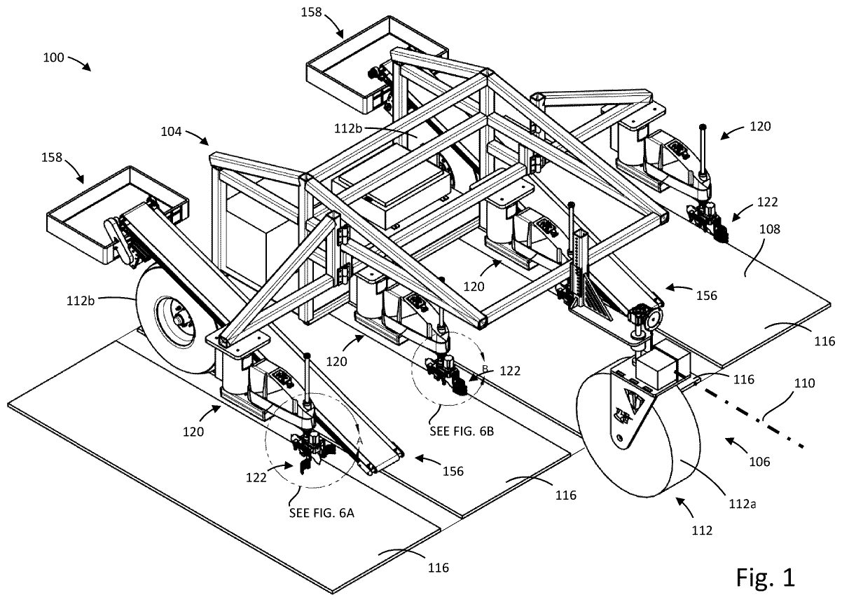

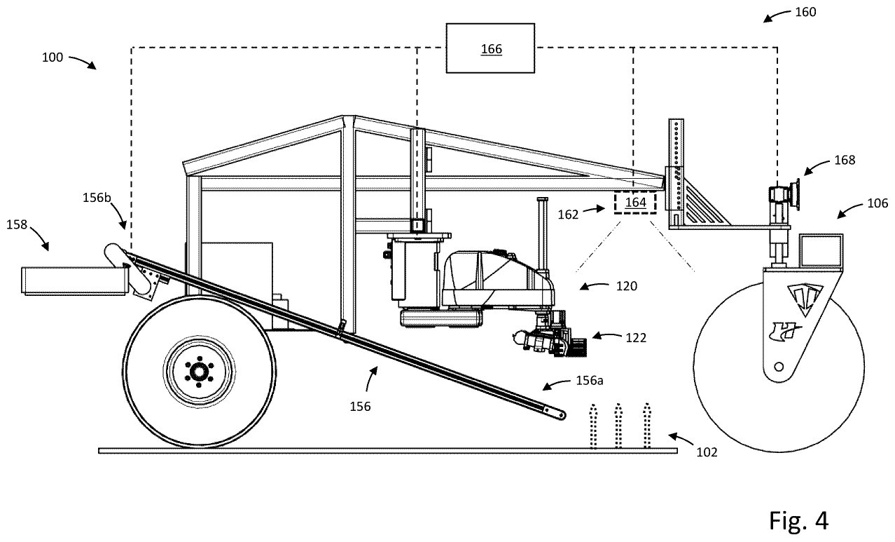

Referring to FIG. 1, an example automated crop harvester 100 for harvesting vegetable crops is illustrated. In the example illustrated, the harvester 100 is configured for harvesting asparagus spears 102 (FIG. 4), and can also be used for harvesting other types of vegetable crops (e.g. broccoli, celery, etc.).

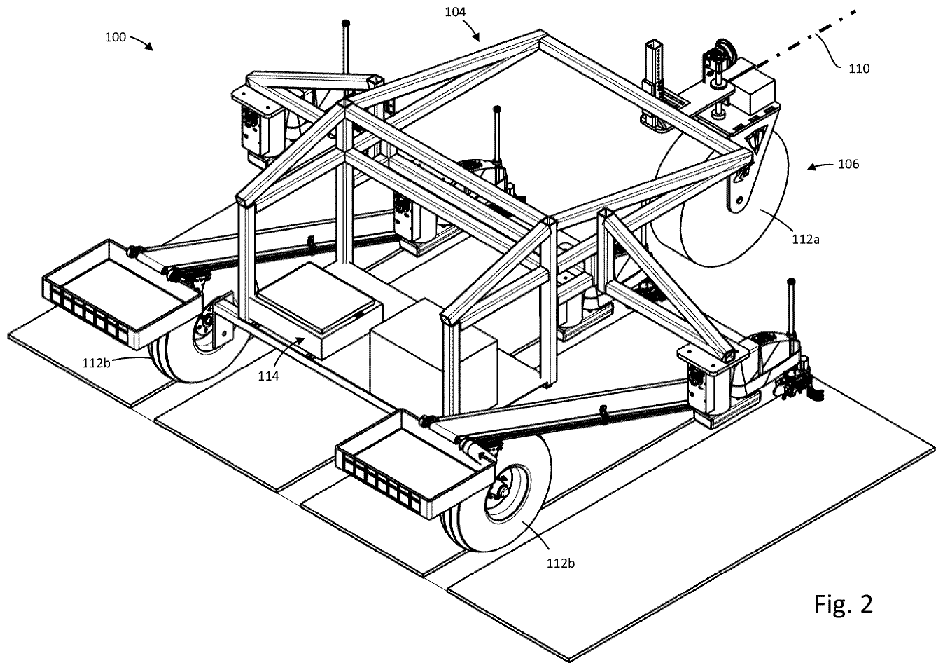

In the example illustrated, the harvester 100 includes a frame 104 and a drive system 106 supporting the frame 104 for movement of the frame 104 along a ground surface 108 in a forward harvesting direction 110. In the example illustrated, the drive system 106 includes a plurality of wheels 112 supporting the frame 104 above the ground surface 108. In the example illustrated, the plurality of wheels 112 include a central front wheel 112a supporting a front of the frame 104 and a pair of laterally spaced apart rear wheels 112b supporting a rear of the frame 104. In the example illustrated, the rear wheels 112b are idler wheels and the central front wheel 112a is powered (e.g. through one or more electric motors) for driving (and steering) the harvester 100. Referring to FIG. 2, in the example illustrated, the harvester 100 includes a power unit 114 (e.g. a battery pack and/or generator) supported by the frame 104 for powering the drive system 106 and other components of the harvester 100. The harvester can optionally include solar panels mounted to the frame 104 for charging the power unit 114.

Referring to FIG. 1, the harvester 100 includes a plurality of robot arms 120 mounted to the frame 104. In the example illustrated, the robot arms 120 are spaced laterally apart from each other generally perpendicular to the harvesting direction 110 for harvesting crops growing in corresponding crop rows 116. In the example illustrated, the harvester 100 includes four robot arms 120 configured for harvesting four corresponding crop rows 116 simultaneously (i.e. one robot arm 120 for each row 116). Each robot arm 120 has end-of-arm tooling 122 adapted to grip and cut the crops from the ground surface. In the example illustrated, the end-of-arm tooling 122 is adapted for harvesting asparagus spears, and in some examples, can be replaced with other tooling (e.g. adapted to harvest other types of vegetable crops).

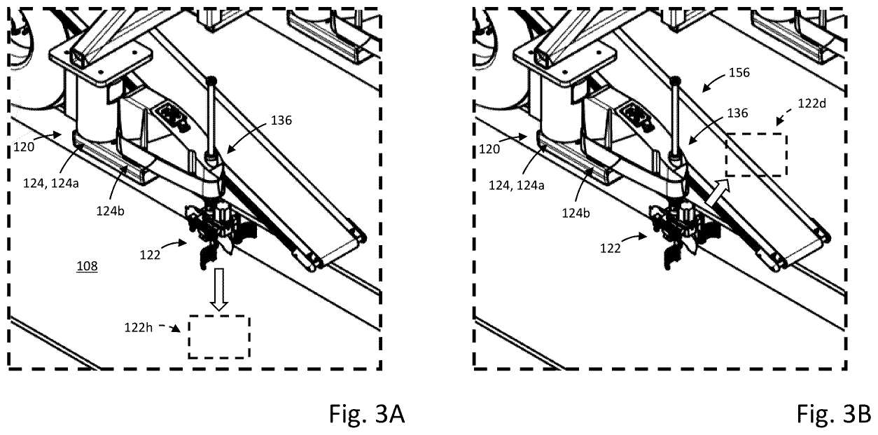

Referring to FIGS. 3A and 3B, in the example illustrated, the end-of-arm tooling 122 is automatically movable relative to the frame 104 between at least one harvesting position (one of which is shown schematically in FIG. 3A at 122h) adjacent the ground surface 108 for gripping and cutting crops projecting from the ground surface, and at least one drop-off position (shown schematically in FIG. 3B at 122d) spaced apart from the harvesting position for releasing the crops for further processing (e.g. for transport along a conveyor 156 as described below). In the example illustrated, the end-of-arm tooling 122 is automatically movable laterally relative to the harvesting direction 110 among a plurality of harvesting positions for alignment with respective crops projecting from the ground surface for cutting and collecting the crops.

In the example illustrated, each robot arm 120 comprises an articulated robot arm having at least one rotary joint 124 for driving movement of the end-of-arm tooling 122 among the harvesting positions, and between the harvesting and drop-off positions. This can help improve cycle time (i.e. time for the end-of-arm tooling 122 to move from the harvesting position to the drop-off position and back) relative to some other types of actuator mechanisms (e.g. some types of gantry-style systems). In the example illustrated, the drop-off position is spaced horizontally apart from the plurality of harvesting positions, and at least one rotary joint 124 of the robot arm 120 is operable to move the end-of-arm tooling 122 horizontally for movement among the harvesting and drop-off positions.

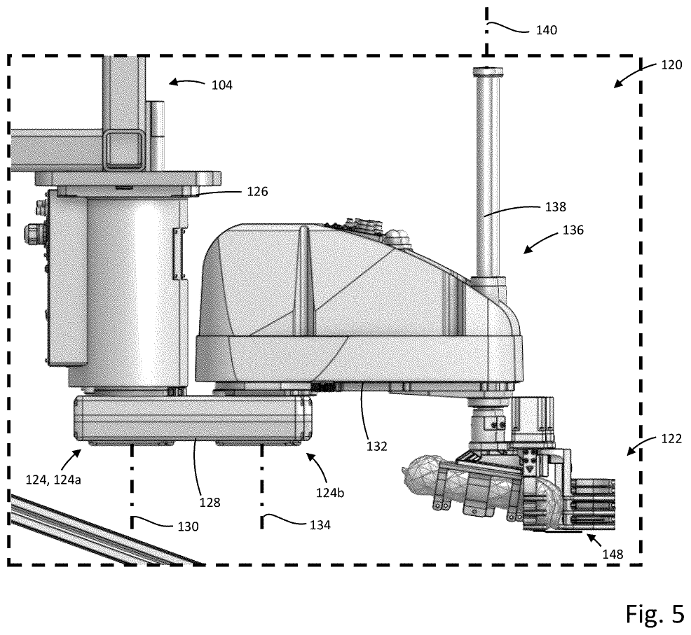

Referring to FIG. 5, in the example illustrated, each robot arm 120 comprises a four-axis selective compliance articulated robot arm (SCARA) having a jointed two-link arm arrangement for driving horizontal movement of the end-of-arm tooling 122. In the example illustrated, each robot arm 120 has a base 126 mounted to the frame 104 and a first link 128 projecting horizontally from the base 126 between a first link inner end and a first link outer end spaced horizontally apart from the first link inner end. The first link inner end is rotatably mounted to the base 126 through a first rotary joint 124a for rotation of the first link 128 about a vertical first (shoulder) axis 130 fixed relative to the base 126. Each robot arm 120 further includes a second link 132 projecting horizontally from the first link outer end between a second link inner end and a second link outer end spaced horizontally from the second link inner end. The second link inner end is rotatably mounted to the first link outer end through a second rotary joint 124b for rotation of the second link 132 about a vertical second (elbow) axis 134 fixed relative to the first link outer end. Each rotary joint 124 has a corresponding servo motor for driving rotation of the corresponding link.

Referring to FIGS. 3A and 3B, in the example illustrated, the drop-off position is at an elevation above the harvesting position, and each arm 120 has a linear actuator 136 operable to translate the end-of-arm tooling 122 vertically for movement between the harvesting and drop-off positions. Referring to FIG. 5, in the example illustrated, the linear actuator 136 is coupled to the second link outer end, and comprises a vertical member 138 extending along a vertical third (wrist) axis 140 fixed relative to the second link outer end. The vertical member 138 is translatable along the third axis 140, and comprises a ball screw in the example illustrated. In the example illustrated, the linear actuator 136 has a corresponding servo motor for driving the vertical translation. The end-of-arm tooling 122 is mounted adjacent a lower end of the vertical member 138 below the second link 132.

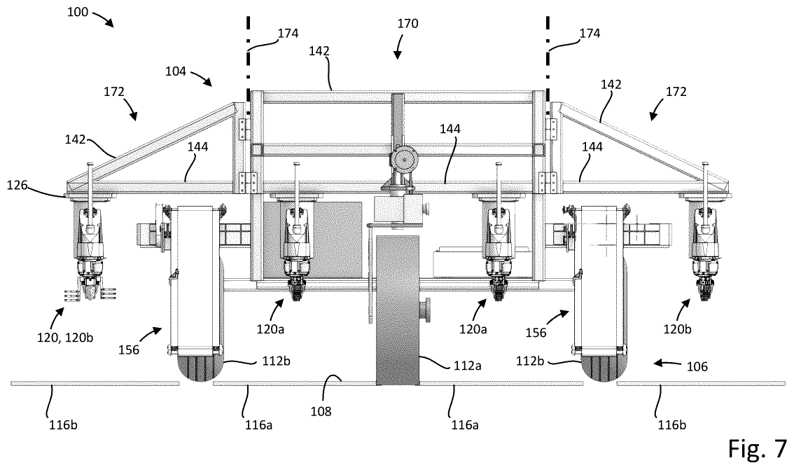

Referring to FIG. 7, in the example illustrated, the frame 104 has a plurality of interconnected frame members 142 fixed in position relative to each other during normal operation. The base 126 of each robot arm 120 is fixed to a corresponding frame member 142. In the example illustrated, each robot arm 120 is suspended from the frame 104 and hangs vertically between the frame 104 and the ground surface 108. In the example illustrated, the frame members 142 comprise one or more horizontally extending cross members 144 positioned above the ground surface 108. The base 126 of each robot arm 120 is mounted to an underside of a cross member 144 for suspending the robot arm 120 from the cross member 144 directly above the ground surface 108.

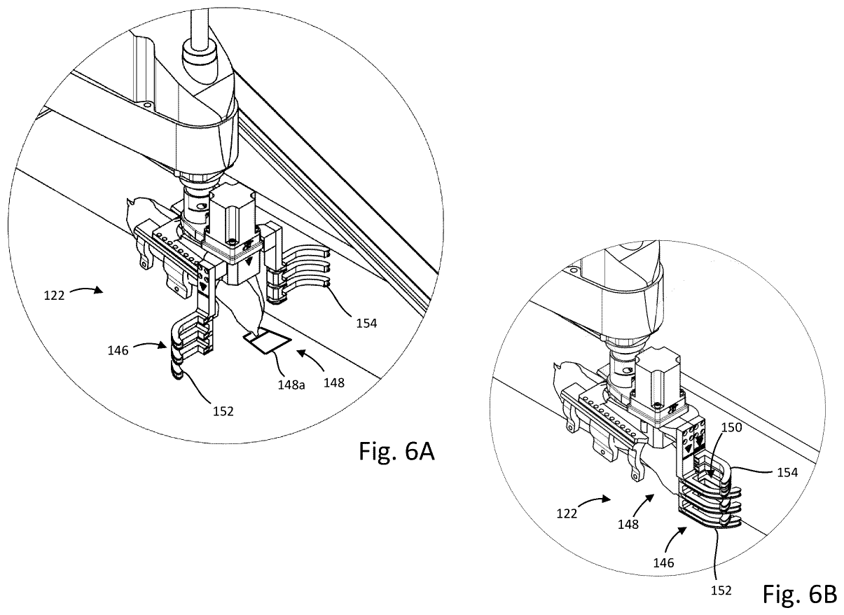

Referring to FIGS. 6A and 6B, in the example illustrated, the end-of-arm tooling 122 comprises a gripper 146 movable between an open position (FIG. 6A) for receiving and releasing the crop, and a closed position (FIG. 6B) for gripping the crop. In the example illustrated, the end-of-arm tooling 122 further includes a cutter 148 (shown schematically in FIGS. 5 and 6A) adjacent the gripper 146 for cutting the crop from the ground surface (e.g. above, at, or below ground level). Referring to FIG. 6B, when in the closed position, the gripper 146 defines a vertical channel 150 for receiving the crop, and the cutter 148 (FIG. 6A) projects under the channel 150 for cutting the crop below the channel 150. The cutter 148 can comprise a blade fixed in position relative to the channel 150 and having a cutting edge 148a (shown schematically in FIG. 6A) directed toward the harvesting direction. The gripper 146 can be shaped to guide the crop into engagement with the blade during forward movement of the end-of-arm tooling 122 relative to the crop. In some examples, the cutter 148 can comprise an oscillating saw (blade) arrangement, with the blade being pivotable about a vertical axis for oscillating back and forth in a horizontal plane (in addition to or in lieu of a fixed blade arrangement).

In the example illustrated, the gripper 146 comprises a plurality of first fingers 152 spaced vertically apart from each other and a plurality of second fingers 154 spaced vertically apart from each other. Referring to FIG. 6B, in the example illustrated, the first and second fingers 152, 154 are vertically offset for interlocking with each other when the gripper is in the closed position to horizontally enclose the channel 150 for holding the crop therein. Referring to FIG. 6A, when the gripper 146 is in the open position, the second fingers 154 are spaced horizontally apart from the first fingers 152 to open a front of the channel 150 for receiving and releasing crops. The gripper 146 can include a liner (e.g. an elastomeric material) on the inner surface of the first and second fingers 152, 154 to facilitate gripping of the crops.

Referring to FIG. 1, in the example illustrated, the harvester 100 includes a plurality of conveyors 156 supported by the frame 104 and extending along the harvesting direction 110 for conveying crops therealong in a rearward direction. Referring to FIG. 4, each conveyor 156 extends between an upstream end 156a adjacent the drop-off position for at least one of the robot arms 120 for receiving crops released from the robot arms 120 at the drop-off position, and a downstream end 156b for depositing the harvested crops into a storage receptacle 158 (e.g. lug, tote, container, etc.) supported by the frame 104 downstream of the conveyor 156. In the example illustrated, each conveyor 156 is inclined, with the downstream end 156b at an elevation above the upstream end 156a. Referring to FIG. 7, in the example illustrated, the harvester 100 includes two conveyors 156 spaced laterally apart from each other. Each conveyor 156 is positioned laterally intermediate a corresponding pair of the robot arms 120 for receiving crops from both robot arms 120 of the pair.

In some examples, the harvester 100 can include a plurality of chutes into which the end-of-arm tooling 122 drops crops at the drop-off position for transfer along the chute to the upstream end of a corresponding conveyor 156 (e.g. through sliding of the crops down the chute). In some examples, each conveyor 156 can comprise a v-belting system, and each chute can be shaped to properly orient the crops for receipt and transport by the v-belting system.

Referring to FIG. 4, in the example illustrated, the harvester 100 includes a control system 160 for controlling operation of the harvester, including the robot arms 120, conveyors 156, and drive system 106. In the example illustrated, the control system 160 has a crop detection system 162 having one or more crop sensors 164 operable to detect positioning of crops projecting from the ground surface relative to the harvester 100. In the example illustrated, the crop sensors 164 are positioned forward of the robot arms 120 for detecting crops advancing toward the robot arms 120 during forward operation of the harvester 100. In the example illustrated, the crop detection system 162 comprises a vision system and the crop sensors 164 comprise imaging sensors operable to generate image data for determining the positioning of the crops. The control system 160 further includes a control unit 166 operable to determine the required harvesting position for the end-of-arm tooling 122 based on the positioning of the crops detected by the crop detection system 162, and control operation of the robot arms 120 to move the end-of-arm tooling 122 between corresponding harvesting and drop-off positions for harvesting the detected crops. The control unit 166 can utilize machine learning (artificial intelligence) algorithms for determination of the crop positioning and control of the robot arms 120 based on the determined crop positioning.

In the example illustrated, the control system 160 further includes a harvester positioning system 168 (e.g. which can comprise a local vision system and/or global positioning system (GPS)) operable to detect positioning of the harvester 100 relative to the ground surface 108. The control unit 166 is operable to control operation of the drive system 106 based on the positioning detected by the positioning system 168 to drive the harvester 100 along a preselected harvesting route. The control unit 166 is further operable to control operation of the conveyors 156, for example, to adjust the conveyor speed based on operating parameters corresponding to harvesting speed and/or quantity, such as, for example, a ground speed of the harvester 100, quantity of crops detected by the crop detection system 162, and/or movement, positioning, and/or cycle time of the robot arms 120.

The control system 160 of the harvester 100 can comprise, for example, one or more processors (e.g. central processing units, digital signal processors, etc.), Field Programmable Gate Arrays (FPGA), application specific integrated circuits (ASIC), and/or other types of control units capable of independently or in combination carrying out the functionality and methods of the present disclosure. In some examples, the control unit 166 can include a plurality of processors, and each processor may be configured to perform dedicated tasks for controlling harvester components. The control system 160 can include computer readable memory for storing computer readable instructions (e.g. defining robot arm motion profiles, harvesting routes, conveyor speeds, and/or other control variables) retrievable, and in some examples adjustable, by the control system 160 or other system components for operation thereof according to the present disclosure. In some examples, some control system components (e.g. one or more processors and/or computer readable memory) can be located remotely and communicate with local control system components (e.g. those mounted to and movable with the frame 104) through wireless communication modules.

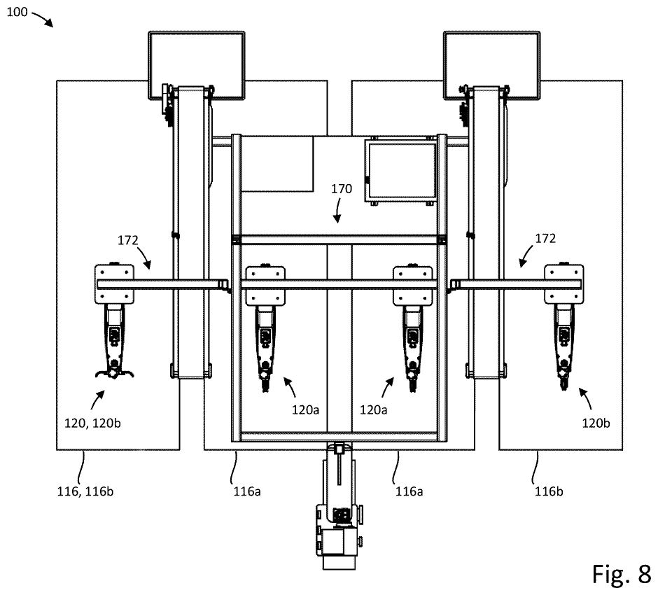

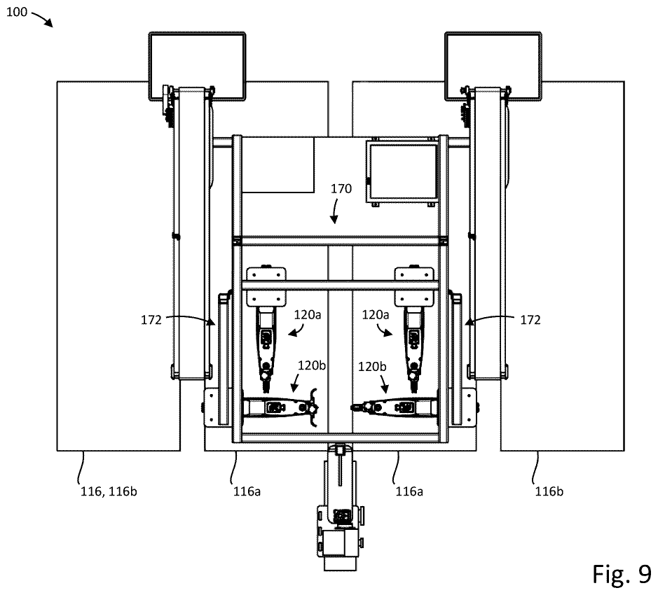

Referring to FIG. 8, in the example illustrated, the robot arms 120 are shown arranged in a parallel configuration, in which work envelopes of the robot arms 120 are spaced generally laterally apart for harvesting crops in corresponding crop rows 116 extending parallel with the harvesting direction 110. Referring to FIG. 9, in the example illustrated, the relative positioning of the robot arms 120 is reconfigurable to a series configuration, in which the work envelopes of at least one pair of adjacent robot arms 120a, 120b are generally in lateral alignment for harvesting crops from a common crop row 116a, which can be helpful during periods of high crop density (e.g. earlier in the growing season).

Referring to FIG. 7, in the example illustrated, the frame 104 is adjustable for reconfiguration of the robot arms 120 between the parallel and series configurations. In the example illustrated, the frame 104 has a central portion 170 supported by the drive system 106. A pair of inner robot arms 120a are mounted to the central portion 170. The frame 104 further includes a pair of side portions 172 movably mounted on laterally opposite sides of the central portion 170. Each side portion 172 has a corresponding outer robot arm 120b mounted thereto. Referring to FIGS. 8 and 9, each side portion 172 is movable relative to the central portion 170 between an extended position (FIG. 8) for positioning the outer robot arm 120b in the parallel configuration with the pair of inner robot arms 120a, and a withdrawn position (FIG. 9) for positioning the outer robot arm 120b in the series configuration with an adjacent inner robot arm 120a.

Referring to FIG. 8, when in the extended position, each side portion 172 projects laterally from the central portion 170 to position the work envelope of the outer robot arm 120b laterally outboard of the central portion 170 (and of the work envelope of the adjacent inner robot arm 120a). Referring to FIG. 9, when in the withdrawn position, each side portion 172 is withdrawn toward the central portion 170 to position the work envelope of the outer robot arm 120b laterally inboard of the central portion 170 and generally in lateral alignment with the work envelope of the adjacent inner robot arm 120a. In the example illustrated, when the side portion 172 is in the withdrawn position, the work envelope of the outer robot arm 120b is generally in front of the work envelope of the adjacent inner robot arm 120a. Referring to FIG. 7, in the example illustrated, each side portion 172 is pivotably mounted to the central portion 170 (e.g. through a pair of vertically spaced apart hinges) for swinging about a vertical swing axis 174 between the extended position (in which the side portion 172 projects laterally from the central portion 170) and the withdrawn position (in which the side portion 172 lies generally flat against the central portion 170, with the outer robot arm 120b oriented generally perpendicular to the adjacent inner robot arm 120a).

In the example illustrated, the central front wheel 112a is positioned laterally intermediate and forward of the pair of inner robot arms 120a for travel along the ground surface 108 between the pair of inner crop rows 116a being harvested by the inner robot arms 120a. In the example illustrated, the pair of inner robot arms 120a are laterally intermediate and forward of the pair of rear wheels 112b. When the robot arms 120 are in the parallel configuration, each rear wheel 112b is positioned laterally intermediate a corresponding outer robot arm 120b and an adjacent inner robot arm 120a for travel along the ground surface 108 between the outer crop row 116b and inner crop row 116a being harvested by the outer robot arm 120b and adjacent inner robot arm 120a. In the example illustrated, each rear wheel 112b is generally in lateral alignment with and under a corresponding conveyor 156.

In operation, the harvester 100 is driven along the ground surface 108 in the harvesting direction 110. The end-of-arm tooling 122 of each robot arm 120 is moved to a corresponding harvesting position (determined based on the detected positioning of the crops) to grip and cut crops from the ground surface 108. While gripping the crop, the end-of-arm tooling 122 is moved to the drop-off position to release the crop, for example, either directly onto the conveyor or onto a chute for transfer to the conveyor and storage receptacle. The movement between the harvesting and drop-off positions is repeated continuously as the harvester is driven along the crop rows to fill the storage receptacles 158 in a continuous harvesting process (e.g. without necessarily requiring the harvester to stop for harvesting the crops). Each storage receptacle 158 can be weighed and indexed to automatically replace a full storage receptacle with an empty storage receptacle.

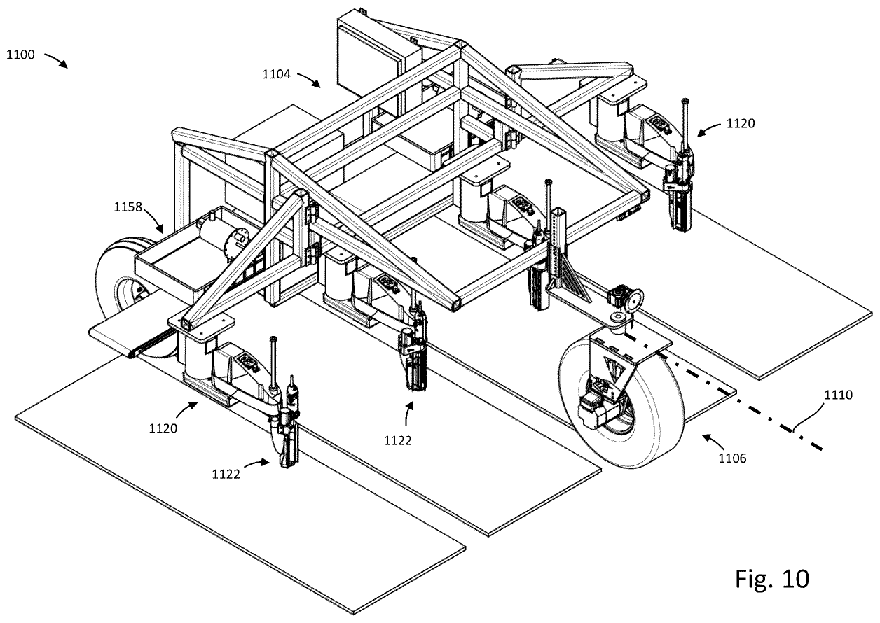

Referring to FIG. 10, another example automated crop harvester 1100 is shown. The crop harvester 1100 has similarities to the harvester 100 and like features are identified using like reference numerals, incremented by 1000.

In the example illustrated, the harvester 1100 includes a frame 1104 and a drive system 1106 supporting the frame 1104 for movement of the frame 1104 along a ground surface in a harvesting direction 1110. In the example illustrated, the harvester further includes a plurality of robot arms 1120 mounted to the frame 1104 for harvesting crops in corresponding crop rows. Each robot arm 1120 has end-of-arm tooling 1122 movable relative to the frame 1104 for alignment with and harvesting of respective crops (e.g. asparagus spears).

The end-of-arm tooling 1122 is movable laterally relative to the frame 1104 among a plurality of harvesting positions for alignment with respective crops spaced laterally apart from each other in a corresponding crop row. In the example illustrated, robot arm 1120 is articulated, and has at least one rotary joint operable to move the end-of-arm tooling 1122 laterally relative to the frame 1104 for lateral alignment with respective crops. In the example illustrated, each arm 1120 has at least one linear actuator operable to translate the end-of-arm tooling 1122 vertically relative to the frame 1104 for vertical alignment with the crops (e.g. for vertical alignment of a cutter of the end-of-arm tooling 1122 with a base of the crops for cutting the crops near the ground surface). In the example illustrated, the robot arms 1120 are shown arranged in a parallel configuration and are reconfigurable to a series configuration through adjustment of the frame 1104 (e.g. in a manner similar to that described with respect to the harvester 100).

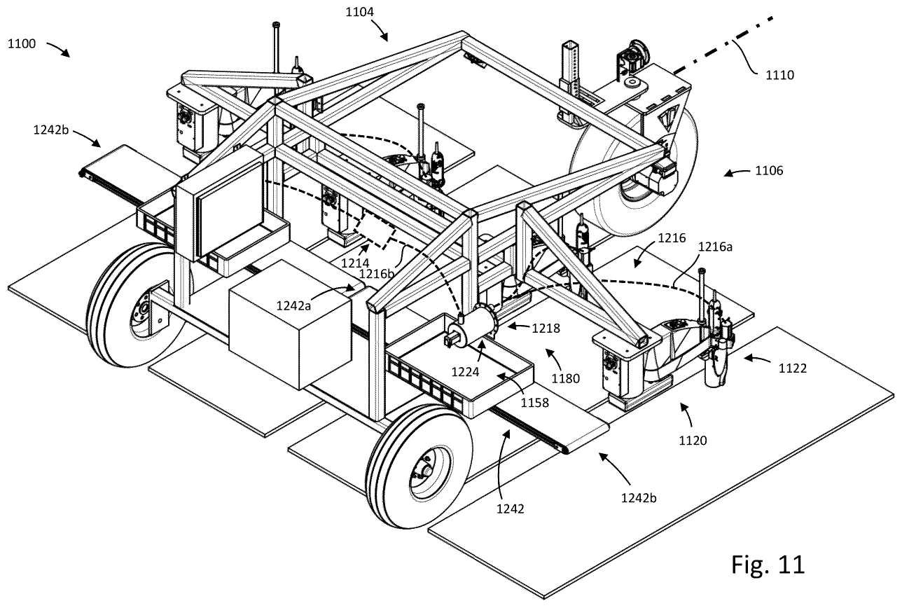

Referring to FIG. 11, in the example illustrated, the harvester 1100 further includes a crop suction system 1180 mounted to the frame 1104 and in fluid communication with each end-of-arm tooling 1122. The suction system 1180 is operable to suction crops harvested (e.g. cut and collected) by the end-of-arm tooling 1122. The suction system 1180 is further configured to transport the crops through suction toward storage receptacles 1158 supported by the frame 1104. In the example illustrated, the suction system 1180 comprises at least one suction drive 1214 (e.g. pump, blower, etc.; one shown schematically in FIG. 11) for generating suction power. The suction system 1180 further includes a conduit system 1216 coupling and providing fluid communication between the at least one suction drive 1214 and each end-of-arm tooling 1122 to translate the suction power into a respective suction force generated at each end-of-arm tooling 1122. In the example illustrated, the suction system 1180 is configured to generate the suction force at each end-of-arm tooling 1122 to suction crops cut by the end-of-arm tooling 1122 and transport the crops through the conduit system 1216 via the suction power for deposit in one or more storage receptacle 1158j supported by the frame 1104.

Referring to FIG. 13, in the example illustrated, each end-of-arm tooling 1122 comprises a cutter 1148 for cutting the crops from the ground surface and a suction head 1182 above the cutter 1148. The suction head 1182 has a suction port 1184 coupled to the suction system 1180 (e.g. through a conduit of the conduit system 1216) and through which crops cut by the end-of-arm tooling 1122 are suctioned for transport to the storage receptacles 1158.

In the example illustrated, the suction head 1182 includes a housing 1186 having an interior 1188 extending along a vertical axis 1190 between a lower end and an upper end of the interior 1188. The housing 1186 has a crop inlet 1192 extending vertically along and open to the interior 1188 for loading crops into the interior 1188 of the housing 1186. In the example illustrated, the crop inlet 1192 is directed forwardly in the harvesting direction 1110, extends vertically over a length of the interior 1188 from the lower end to the upper end of the interior 1188, and is vertically elongate for receiving elongate vegetable crops (e.g. asparagus stalks). In the example illustrated, the suction port 1184 extends through a sidewall of the housing 1186 and is open to the interior 1188 of the housing 1186. The suction port 1184 provides fluid communication between the interior 1188 of the housing 1186 and the conduit system 1216. The suction port 1184 is spaced circumferentially apart from the crop inlet 1192 (about the vertical axis 1190 of the interior 1188) for suctioning crops received in the interior 1188.

In the example illustrated, the cutter 1148 of the end-of-arm tooling is positioned at the lower end of the interior 1188 and has a cutting edge under and in alignment with the crop inlet 1192 for cutting the crops from the ground surface for loading into the interior 1188 through the crop inlet 1192. The cutter 1148 is at an elevation below the interior 1188, suction port 1184, and crop inlet 1192, and the crop inlet 1192 extends upwardly from the cutter 1148 toward the upper end of the interior 1188.

Referring to FIG. 14, in the example illustrated, the suction head 1182 includes a rotary feeder 1194 in the interior 1188 of the housing 1186. The rotary feeder 1194 is rotatable about the vertical axis 1190 relative to the housing 1186 for moving crops 1102 received in the interior 1188 from the crop inlet 1192 toward the suction port 1184. The rotary feeder 1194 is rotatable between at least one loading position for receiving the crops 1102 from the crop inlet 1192 and at least one suction position for positioning the received crops 1102 adjacent the suction port 1184 for suctioning of the crops 1102 from the interior 1188.

In the example illustrated, the rotary feeder 1194 includes a plurality of vanes 1196 extending vertically across the interior 1188 and spaced circumferentially apart from each other about the vertical axis 1190 for separating the interior 1188 into a plurality of chambers 1198 spaced circumferentially apart for each other. In the example illustrated, the vanes 1196 are movable about the axis 1190 to form at least one loading chamber 1198a in alignment with the crop inlet 1192 for receiving crops, and at least one suction chamber 1198b spaced circumferentially apart from the loading chamber 1198a and in fluid communication with the suction port 1184 for suctioning the crops from the suction chamber 1198b. In the example illustrated, the rotary feeder 1194 includes three vanes 1196 spaced equally apart from each other about the axis 1190 for separating the interior 1188 into three chambers 1198, including one loading chamber 1198a, one suction chamber 1198b circumferentially adjacent the loading chamber 1198a, and one intermediate chamber 1198c circumferentially intermediate the loading and suction chambers 1198a, 1198b.

In the example illustrated, the rotary feeder 1194 is in the form of a rotary airlock (star) valve, and the suction chamber 1198b is generally in fluid isolation of the loading chamber 1198a (and crop inlet 1192) to help maintain sufficient air pressure differential for suctioning of crops from the suction chamber 1198b. In the example illustrated, the housing 1186 further includes an air inlet 1200 passing through the housing 1186 and open to the suction chamber 1198b. In the example illustrated, the air inlet 1200 passes radially through the housing sidewall. The air inlet 1200 provides fluid communication between the suction chamber 1198b and environment external the housing 1186 for drawing air into the suction chamber 1198b from the environment. Referring to FIG. 13, in the example illustrated, the air inlet 1200 is open to the suction chamber 1198b at an elevation below the suction port 1184 adjacent the lower end of the interior 1188. This can facilitate replacement of air being suctioned out of the suction chamber 1198b and direct air flow upwardly from the air inlet 1200 to the suction port 1184 to help draw crops received in the suction chamber 1198b upwardly into the suction port 1184. In the example illustrated, the suction head 1182 includes a snorkel 1202 in fluid communication with the air inlet 1200 and extending upwardly along an exterior of the housing 1186 from the air inlet 1200 to an air intake 1204 open to the environment. In the example illustrated, the air intake 1204 is at an elevation above the air inlet 1200 and directed rearwardly toward the frame 1104 away from the crop inlet 1192. This can inhibit intake of debris through the air inlet 1200 (e.g. from the ground surface or from cutting of the crops) and/or clogging of the air inlet 1200 during operation.

Referring still to FIG. 13, in the example illustrated, the cutter 1148 comprises an oscillating blade 1149 oriented normal to the vertical axis 1190 and coupled to an oscillating drive 1206 for driving oscillation of the blade 1149 back-and-forth about the vertical axis. In the example illustrated, the oscillating drive 1206 is mounted atop the housing 1186 and coupled to the blade 1149 through a blade drive shaft 1208 passing through the interior 1188 along the vertical axis 1190 between a bottom end coupled to the blade 1149 and a top end vertically opposite the bottom end and coupled to the oscillating drive 1206. In the example illustrated, the oscillating drive 1206 is mounted overtop of the blade drive shaft 1208.

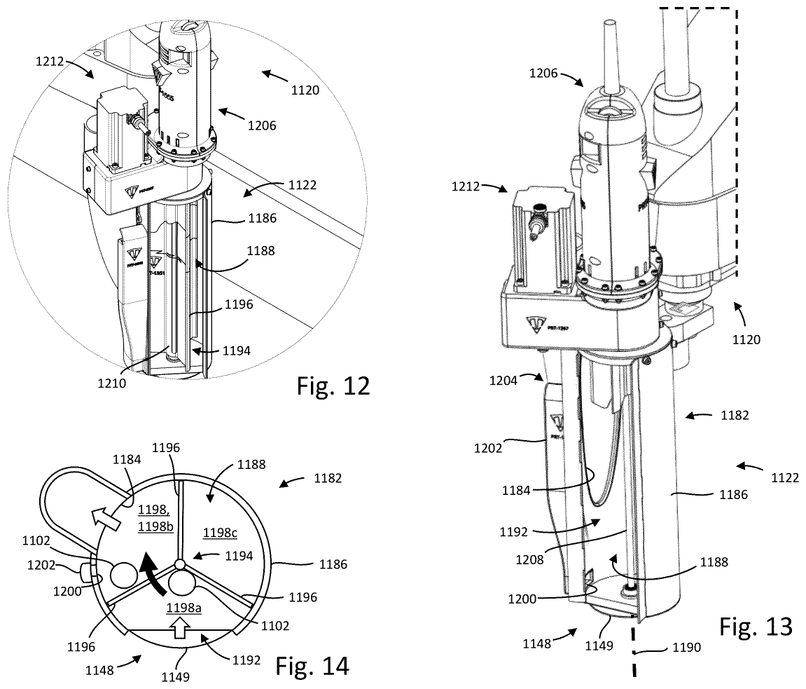

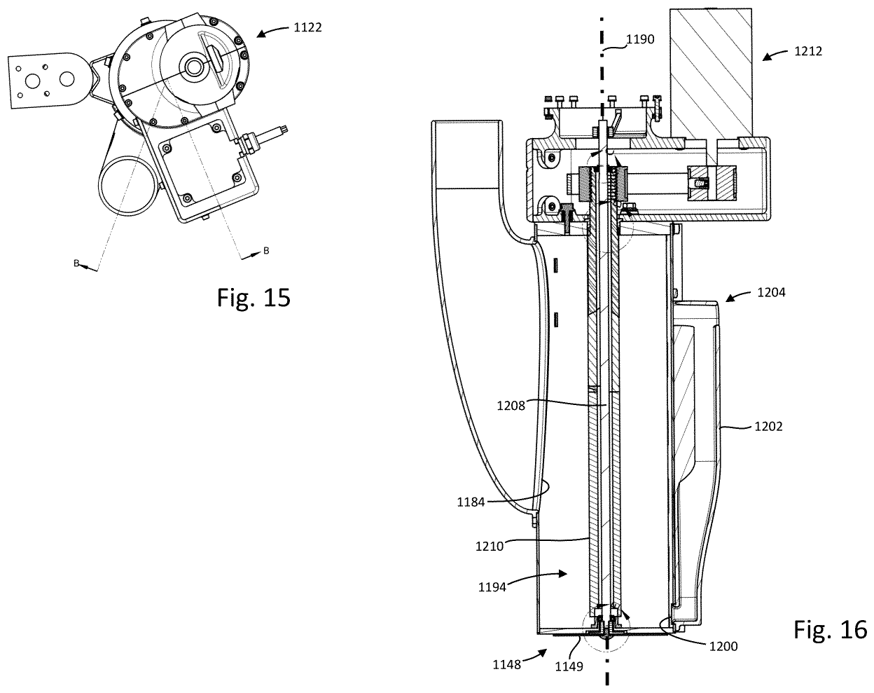

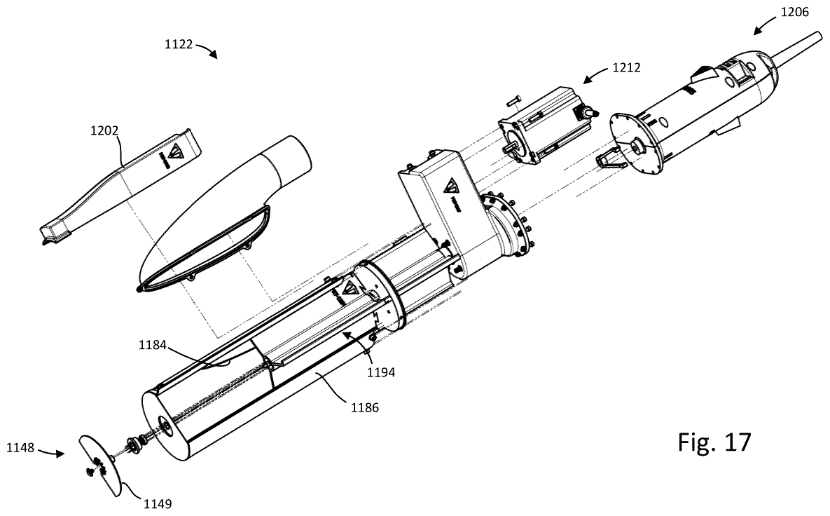

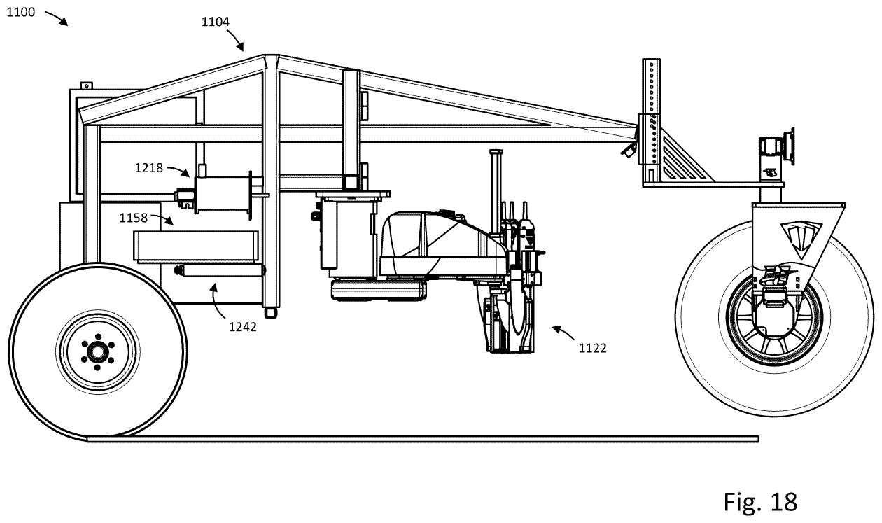

Referring to FIG. 12, in the example illustrated, the rotary feeder 1194 has a feeder drive shaft 1210 passing through the interior 1188 along the vertical axis 1190 and from which the vanes 1196 project radially from the shaft 1210 to a radially inner surface of the housing 1186. Referring to FIG. 16, in the example illustrated, the feeder drive shaft 1210 is hollow and mounted over and coaxial with the blade drive shaft 1208, which extends vertically through the hollow feeder drive shaft 1210. In the example illustrated, rotation of the rotary feeder 1194 is driven by a feeder drive 1212 coupled to the feeder drive shaft 1210. In the example illustrated, the feeder drive 1212 is mounted atop the housing 1186 and is spaced horizontally apart from the oscillating drive 1206. The feeder drive 1212 is horizontally offset from the rotary feeder 1194, and is coupled to the rotary feeder 1194 in a belt-drive configuration to accommodate the horizontal offset.

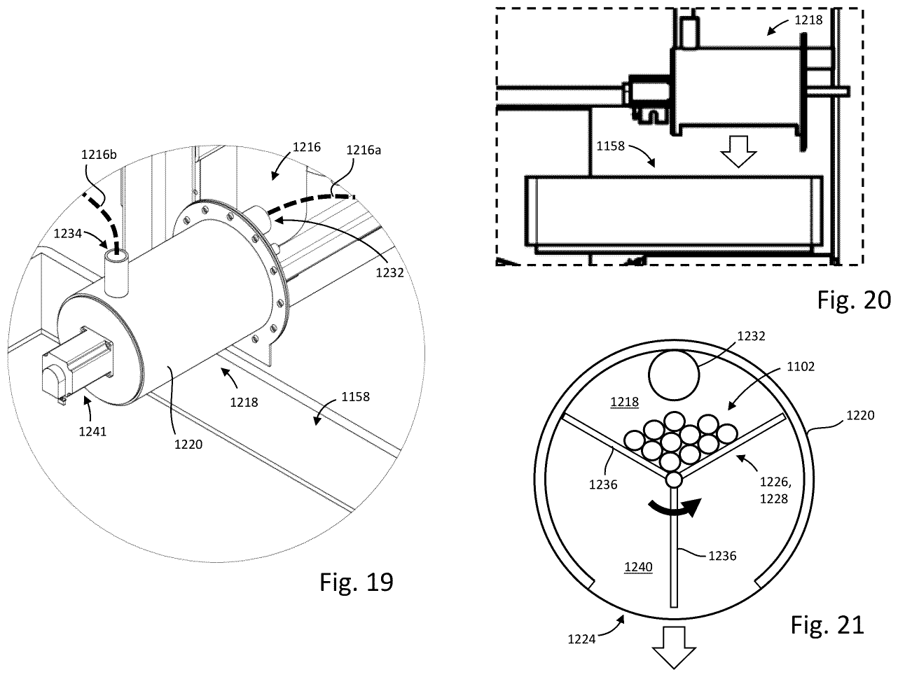

Referring to FIG. 19, in the example illustrated, one or more crop collection chambers 1218 are positioned in the air flow path(s) of the conduit system 1216 for collecting crops being conveyed through the conduit system 1216. In the example illustrated, the suction system 1180 includes a pair of the collection chambers 1218, one on each side of the frame 1104. Each collection chamber 1218 has a chamber inlet 1232 coupled to the suction ports 1184 of a respective pair of robot arms 1120 through an upstream conduit assembly 1216a of the conduit system 1216 through which the crops are conveyed to the collection chamber 1218. Each collection chamber 1218 has an outlet 1234 spaced apart from the inlet 1232 and coupled to the suction drive 1214 through a downstream conduit assembly 1216b of the conduit system 1216. The chamber inlet 1232 and chamber outlet 1234 are at an elevation above a floor of the collection chamber 1218 to facilitate dropping of the crops down into the collection chamber 1218 when received through the inlet 1232 and inhibit the crops from being suctioned out from the chamber outlet 1234.

In the example illustrated, each collection chamber 1218 is provided in a hopper 1220 having a discharge mechanism for discharging the plurality of crops from the collection chamber 1218 for deposit into a respective storage receptacle 1158 positioned under the hopper 1220. Referring to FIG. 21, in the example illustrated, the discharge mechanism includes a discharge opening 1224 below the collection chamber 1218 (and vertically opposite the chamber outlet 1234) and a discharge valve 1226 between the collection chamber 1218 and the discharge opening 1224. The discharge valve 1226 is operable to control discharge of the plurality of crops 1102 from the collection chamber 1218 through the discharge opening 1224. In the example illustrated, the discharge valve 1226 comprises a rotary feeder 1228 rotatable about a horizontal axis between at least one collection position for receiving the crops 1102 in the collection chamber 1218 from the inlet 1232 and at least one discharge position for discharging the received crops 1102 through the discharge opening 1224 for deposit into the storage receptacle 1158 (FIG. 19).

In the example illustrated, the rotary feeder 1228 includes a plurality of vanes 1236 spaced circumferentially apart from each other about the horizontal axis and separating an interior of the hopper 1220 into a plurality of chambers 1238, including the collection chamber 1218 and a discharge chamber 1240 in alignment with the discharge opening 1224. Rotation of the rotary feeder 1228 (e.g. through operation of a hopper drive 1241 shown in FIG. 19) rotates the vanes 1236 about the horizontal axis for moving the crops received in the collection chamber 1218 to the discharge chamber 1240 for discharge of the received crops through the discharge opening 1224 under gravity. In the example illustrated, the rotary feeder 1228 is in the form of a rotary airlock (star) valve, and the collection chamber 1218 is generally in fluid isolation of the discharge chamber 1240 (and discharge opening 1224) to help generate sufficient air pressure differential through the conduit system 1216 for drawing air from the inlet 1232 to the outlet 1234 to suction the crops into the collection chamber 1218.

In the example illustrated, the harvester 1100 includes one or more conveyors 1242 mounted to the frame 1104 for supporting the storage receptacles 1158. In the example illustrated, the conveyors 1242 extend perpendicular to the harvesting direction 1110. In the example illustrated, the harvester 1100 includes a pair of conveyors 1242 positioned on laterally opposite sides of the frame 1104 and under respective collection chambers 1218 for supporting respective storage receptacles 1158 under the collection chambers 1218. Each conveyor 1242 extends between an upstream end 1242a for loading storage receptacles 1158 onto the conveyor 1242, and a downstream end 1242b from which the storage receptacles 1158 are ejected (e.g. for deposit onto the ground surface for subsequent processing). In the example illustrated, the upstream end 1242a of each conveyor 1242 is positioned laterally inwardly toward a center of the frame 1104 (laterally inboard of the frame 1104, in the example illustrated). The downstream end 1242b of each conveyor 1242 is positioned laterally outwardly away from the center of the frame 1104 (laterally outboard of the frame 1104, in the example illustrated).

In the example illustrated, the discharge opening 1224 of each hopper 1220 is positioned overtop of a respective conveyor 1242. Each conveyor 1242 is operable to advance the storage receptacle 1158 under the discharge opening 1224 of the collection chamber 1218 for receiving crops discharged from the collection chamber 1218. Each conveyor 1242 is operable to index the storage receptacle 1158 relative to the discharge opening 1224, for example, to facilitate even distribution of crops in the storage receptacle 1158. For example, once a first portion of the storage receptacle 1158 under the discharge opening 1224 is filled with crops, the conveyor 1242 is operable to advance the storage receptacle 1158 to move the filled, first portion downstream of the discharge opening 1224, and position an adjacent unfilled, second portion of the storage receptacle 1158 into alignment with the discharge opening 1224. The process can be repeated until the storage receptacle 1158 is filled with crops. Once filled, the conveyor 1242 is operable to advance the full storage receptacle 1158 toward the downstream end 1242b for ejection from the harvester 1100. An empty storage receptacle can then be advanced along the conveyor 1242 into alignment with the discharge opening 1224 for receiving crops from the discharge opening 1224 to continue the automated mass harvesting process. Empty storage receptacles can be fed onto the conveyor 1242 automatically, for example, through operation of a receptacle loader holding a plurality of empty storage receptacles stacked one atop another and configured for loading the storage receptacles one-by-one onto the conveyors 1242. In some examples, empty storage receptacles can be fed onto the conveyors 1242 manually by an operator.

In the example illustrated, the harvester 1100 further includes a control system (e.g. similar to the system 160) for controlling operation of the harvester 1100, including the robot arms 1120, conveyors 1242, and drive system 1106, based on signals received from, for example, a crop detection system and a harvester positioning system (e.g. similar to the detection and positioning systems 162, 168).

1. An automated crop harvester comprising:
a) a frame;
b) a drive system supporting the frame for movement of the frame along a ground surface in a harvesting direction; and
c) a plurality of robot arms mounted to the frame and spaced laterally apart from each other generally perpendicular to the harvesting direction for harvesting crops in corresponding crop rows, each robot arm having end-of-arm tooling automatically movable laterally relative to the frame into alignment with respective crops projecting from the ground surface for cutting and collecting the crops.

2. The harvester of claim 1, further comprising a crop suction system mounted to the frame and in fluid communication with each end-of-arm tooling, the suction system operable to generate a suction force at each end-of-arm tooling to suction crops cut by the end-of-arm tooling and transport the crops to a storage receptacle supported by the frame.

3. The harvester of claim 2, wherein each end-of-arm tooling comprises a suction head having a suction port coupled to the suction system and through which the crops are suctioned for transport toward the storage receptacle.

4. The harvester of claim 3, wherein the suction head includes a housing having an interior extending along a vertical axis between a lower end and an upper end of the interior, the housing having a crop inlet extending vertically along and open to the interior for loading crops into the interior, and the suction port open to the interior of the housing and spaced apart from the crop inlet for suctioning crops received in the interior.

5. The harvester of claim 4, wherein the end-of-arm tooling includes a cutter at the lower end of the interior in alignment with the crop inlet for cutting the crops from the ground surface for loading into the interior through the crop inlet.

6. The harvester of claim 4, wherein the suction head includes a rotary feeder in the interior and rotatable about the vertical axis relative to the housing for moving crops received in the interior from the crop inlet toward the suction port.

7. The harvester of claim 6, wherein the rotary feeder includes a plurality of vanes extending vertically along the interior and spaced circumferentially apart from each other for separating the interior into a plurality of circumferentially spaced apart chambers, including at least one loading chamber in alignment with the crop inlet for receiving crops, and at least one suction chamber spaced circumferentially apart from the loading chamber and in fluid communication with the suction port for suctioning the crops from the suction chamber.

8. The harvester of claim 3, wherein the suction system comprises at least one suction drive for generating the suction force, and a conduit system coupling and providing fluid communication between the suction drive and the suction port of each end-of-arm tooling for conveying the crops through the conduit system.

9. The harvester of claim 8, wherein the conduit system comprises one or more collection chambers for collecting crops being conveyed through the conduit system, each collection chamber having a chamber inlet coupled to one or more suction ports through an upstream conduit assembly of the conduit system and a chamber outlet coupled to the suction drive through a downstream conduit assembly of the conduit system.

10. The harvester of claim 9, wherein each collection chamber is provided in a hopper having a discharge mechanism operable to selectively discharge crops from the collection chamber for deposit into a respective storage receptacle under the hopper.

11. The harvester of claim 10, wherein the discharge mechanism comprises a discharge opening below the collection chamber and a discharge valve between the collection chamber and the discharge opening, the discharge valve operable to selectively discharge the crops from the collection chamber through the discharge opening for deposit into the storage receptacle.

12. The harvester of claim 11, wherein the discharge valve comprises a rotary feeder rotatable about a horizontal axis between at least one first position for receiving the crops in the collection chamber and at least one second position for discharging the received crops through the discharge opening.

13. The harvester of claim 11, further comprising at least one conveyor mounted to the frame for advancing storage receptacles into alignment with the discharge opening of a respective hopper for receiving crops discharged from the hopper.

14. The harvester of claim 1, wherein each arm has at least one rotary joint operable to move the end-of-arm tooling laterally relative to the frame for lateral alignment with respective crops, and at least one linear actuator operable to translate the end-of-arm tooling vertically relative to the frame for vertical alignment with the crops.

15. The harvester of claim 1, wherein the robot arms are arranged in a parallel configuration, in which the work envelopes of the robot arms are spaced laterally apart for harvesting crops in corresponding crop rows extending parallel with the harvesting direction, and wherein the relative positioning of the robot arms is reconfigurable to a series configuration in which the work envelopes of at least one pair of adjacent robot arms are generally in lateral alignment for harvesting crops from a common crop row.

16. The harvester of claim 15, wherein the frame is adjustable for reconfiguration of the robot arms between the parallel and series configurations.

17. The harvester of claim 1, further comprising a control system including a crop detection system having one or more crop sensors operable to detect positioning of crops projecting from the ground surface relative to the harvester, and a control unit operable to control operation of the robot arms based on the positioning of the crops to move the end-of-arm tooling into alignment with the crops.

18. The harvester of claim 17, wherein the crop detection system comprises a vision system including one or more imaging sensors operable to generate image data for determining the positioning of the crops.

19. An automated crop harvester comprising:
a) a frame;
b) a drive system supporting the frame for movement of the frame along a ground surface in a harvesting direction; and
c) a plurality of robot arms mounted to the frame for harvesting crops, each robot arm having end-of-arm tooling movable relative to the frame for alignment with and harvesting of respective crops; and
d) a crop suction system mounted to the frame and configured to suction crops harvested by the end-of-arm tooling and transport the crops through suction toward one or more storage receptacles supported by the frame.

20. The harvester of claim 19, wherein each end-of-arm tooling comprises a cutter for cutting the crops from the ground surface and a suction head above the cutter, the suction head having a suction port coupled to the suction system and through which crops cut by the end-of-arm tooling are suctioned for transport toward the one or more storage receptacles.
